(19) United States
(12) Patent Application Publication
(10) Pub. No.: US 2009/0024577 A1
(43) Pub. Date: Jan. 22, 2009

(54) SYSTEM AND METHOD FOR ORGANIZING, POSTING AND SEARCHING INFORMATION ON A NETWORK

(76) Inventors: Gregory Prestel, Camas, WA (US); Rohan Shetty, Hopatcong, NJ (US); Michael Consilvio, Hillsborough, NJ (US)

Correspondence Address: ADVANTIA LAW GROUP, 9035 SOUTH 1300 EAST, SUITE 200, SANDY, UT, 84094, US

(21) Appl. No.: 11/780,658

(22) Filed: Jul. 20, 2007

(51) Int. Cl. G06F 7/10; G06F 17/30

(52) U.S. Cl. 707/3; 707/E17.014

(57) ABSTRACT

A system, method, computer readable storage medium comprising computer readable program code for posting and searching specific content on a network, comprising: providing an image, the image including a first characteristic, and wherein the image is indexed to a search category; providing a sub-category indicator, configured to represent a sub-category associated with the image; providing a description associated with the sub-category indicator; and incorporating the image and the sub-category identifier into network content. The system and method further comprises: searching a network for the image and indexing the location of the image according to the sub-category indicator. The system and method may be applicable to network information providers/seekers using a broad range of search categories, such as employment, shopping, sports, news, social networks, adult content, and network spam. The system and method provide an improved method for organizing the vast amounts of data on networks, such as the Internet.

### BACKGROUND OF THE INVENTION

1. Field of the Invention

The present invention relates to systems and methods of organizing a network such as the Internet, specifically to systems and methods for organizing, posting, searching, and locating specific content or information on a network, while filtering out undesirable network content.

2. Description of the Related Art

Networks such as the internet, have been providing users with the ability to access near infinite amounts of data and information from anywhere in the world. Technological advances in the computer and networking industries have made it increasingly simpler to post information, images, text, indeed, any type of data over a network such as the internet. In response, tools and other resources, such as search engines, webcrawlers, etc. have been developed to assist information seekers in searching, accessing, filtering, and otherwise sorting through such vast amounts of information.

Currently available network browsing tools are proficient in searching through network based data; however, the current network browsing tools typically fail in locating specific network locations or content. For example, a typical search engine searches through a network locating specific search terms as inputted by an information seeker and then indexes and displays the most relevant results. Unfortunately, in many cases, the displayed results include large amounts of both desired and undesired content. Undesired content is not only cumbersome, but may also pose a threat to either to the viewer or the computer, such as adult content, virus and spam laden network locations, and so forth.

Additionally, the current network browsing tools enhance a network information provider's ability to more efficiently disseminate information to those information seekers searching content associated with the information provider. For example, an online retail store, Store A, may advertise, be affiliated with, and/or be listed in the results of a particular search. However, as mentioned previously, because search results include an enormous amount of both desired and undesired locations, Store A's content may go unnoticed by the search initiator. Additionally, the search initiator/information seeker may be wary about using search results due to potentially undesired content.

In order to exclude undesired network locations and content many network locations have been developed which enable an information seeker or information provider to search within that specific location. For example, an information provider, such as an employer hoping to find a particular employee type, may post a job with a particular network employment listing, such as Monster.com™.

Some improvements have been made in the field. Examples include, but are not limited to the references described below, which references are incorporated by reference herein:

U.S. Pat. No. 6,370,510, issued to McGovern et al., discloses a method and apparatus for providing interactive computer-driven employment recruiting service. The method and apparatus enables an employer to advertise available positions on the Internet, directly receive resumes from prospective candidates, and organize and screen the received resumes. The method and apparatus further are capable of monitoring employment advertisements for a job seeker and automatically notifying the job seeker when a position for which the job seeker is suitable becomes available. The method and apparatus further enables a plurality of companies to advertise job positions at a single location accessible via the Internet by a job seeker, and enables the job seeker to communicate directly with a company via the Internet if the job seeker is interested in exploring further information pertaining to an available position at that company.

U.S. Pat. No. 7,099,872, issued to Carpenter et al., discloses a method of managing employment data so as to provide access to the employment data via the Internet. The method includes the steps of determining whether a web site contains employment data, formatting, parsing and storing the employment data and corresponding URL into a database, automatically searching the database for matching employment data, and contacting the employer representative as to the matched employment data.

U.S. Pat. No. 6,757,674, issued to Wiens et al., discloses a method and system for querying multiple career websites from a single interface is disclosed, where each of the websites comprises a plurality of web pages having site-specific fields requiring input of data. The method and system include collecting information from a user, and mapping the user information to the site-specific fields of each of the career websites. The method and system further include automatically filling-in the site-specific fields of each of the career websites with the mapped user information, and forming respective query strings from the filled-in site-specific fields for each of the career websites. The respective query strings are then submitted to the corresponding career websites.

The current network searching, browsing, and posting tools heretofore known suffer from a number of disadvantages which include: failing to exclude undesired network locations and content in search results, limiting network search results to only a particular network location and/or listing, limiting the amount of network exposure to information providers, inadequately excluding adult and other undesired content from search results, and/or so forth.

What is needed is a system and method of organizing, posting, and searching for specific information on a network that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available systems and method for organizing, searching, browsing and disclosing network information. Accordingly, the present invention has been developed to provide system and method for organizing, posting, and searching specific content on a network.

In one embodiment there is a method and/or computer readable storage medium comprising computer readable program code for organizing, posting, and/or searching specific content on a network and/or configured to execute on a processor, the program code and/or method including instructions for performing the steps of: providing an image, the image including a first characteristic, and/or wherein the image is indexed to a search category; providing a sub-category indicator, configured to represent a sub-category associated with the image; providing a description associated with the sub-category indicator; and/or incorporating the image, the sub-category identifier, and/or the description into network content.

In another embodiment, the method and/or computer readable program code further includes instructions for establishing ownership rights to the image; searching a network for the image; and/or indexing the location of the image according to the sub-category indicator. Additionally, the method and/or program may comprise the step of sorting the index according to data selected from the group consisting of: the image, the sub-category indicator, the description, and/or any combinations thereof.

In another embodiment, there is a system for organizing, posting, and searching specific content on a network. The system may comprise: a network communication module; and/or a data uploading module in communication with the network module, and/or configured to upload data into network content. The data uploading module may include instructions for: uploading an image, the image indexed to a search category, and/or the image including a first characteristic; uploading a sub-category indicator, the sub-category indicator being associated with the image; and/or uploading a description associated with the sub-category indicator.

In yet another embodiment, the system may also include a search module in communication with the network communication module; the search module may be configured to search network content. The search module may include instructions for searching the network for the image and/or indexing the location of the image according to the sub-category indicator. Additionally, the system may include a data sorting module in communication with the network communication module, and/or including instructions for sorting the index according to data selected from the group consisting of: the image, the sub-category indicator, the description, and any combinations thereof.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). Understanding that these drawing(s) depict only typical embodiments of the invention and are not therefore to be considered to be limiting of its scope, the invention will be described and explained with additional specificity and detail through the use of the accompanying drawing(s), in which:

FIG. 1 is a block diagram illustrating a system and method for organizing, posting, and searching specific content on a network, according to one embodiment of the invention;

FIG. 2 illustrates a plurality of images indexed to a plurality of categories, according to one embodiment of the invention;

FIG. 3 illustrates an exemplary image indexed to a category and including a sub-category index, according to one embodiment of the invention;

FIG. 4 illustrates an exemplary image, sub-category indicator, and description, according to one embodiment of the invention;

FIG. 5 is a flowchart illustrating a method for posting and searching specific content on a network, according to one embodiment of the invention;

FIG. 6 is a network diagram of a system for organizing, posting, and searching specific content on a network, according to one embodiment of the invention;

FIG. 7 is a block diagram of a system for organizing, posting, and searching specific content on a network, according to one embodiment of the invention;

FIG. 8 illustrates a relationship between an image owner and an information provider, according to one embodiment of the invention;

FIG. 9 is a flowchart illustrating a method for an information seeker searching specific content on a network, according to one embodiment of the invention; and

FIG. 10 is a flowchart illustrating a method for an information provider for incorporating an image and/or sub-category indicator into network content, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. Various databases used herein may include: show data, participant data; sponsor data; financial institution data; and/or like data useful in the operation of the present invention. As those skilled in the art will appreciate, any computers discussed herein may include an operating system (e.g., Windows NT, 95/98/2000, Windows Vista, OS2, UNIX, Linux, Solaris, MacOS, etc.) as well as various conventional support software and drivers typically associated with computers. The computers may be in a home or business environment with access to a network. In an exemplary embodiment, access is through the Internet through a commercially-available web-browser software package.

As set forth in the specification, the system and method of the invention may facilitate the providing information to participants through multiple media sources and may allow the information providers and/or information seekers to receive and provide information via similar multiple media sources. The multiple media sources may include, for example, chat room, internet web pages, email, or the like. The present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may employ and/or include code and/or software used to detect or prevent security issues with a client-side scripting language, such as JavaScript, VBScript or the like. For a basic introduction of cryptography and network security, the following may be helpful references: (1) “Applied Cryptography: Protocols, Algorithms, And Source Code In C,” by Bruce Schneier, published by John Wiley & Sons (second edition, 1996); (2) “Java Cryptography” by Jonathan Knudson, published by O'Reilly & Associates (1998); (3) “Cryptography & Network Security: Principles & Practice” by William Stalling, published by Prentice Hall; all of which are hereby incorporated by reference.

Additionally, many of the functional units and/or modules herein are described as being “in communication” with other functional units and/or modules. Being “in communication” refers to any manner and/or way in which functional units and/or modules, such as, but not limited to, servers, computers, laptop computers, PDAs, modules, and other types of hardware and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

Currently an information provider, such as an employer or employment website, is able to organize network content such that the content targets specific and/or desired applicants. However, the information provider is limited to only those on the particular network employment listings and those potential applicants searching those listings. In a likewise manner an information seeker, such as a job hunter or applicant, may search for specific job types at employment sites, thereby excluding undesired content. However again, the applicant's search results are only limited to those postings available through the particular network employment listing.

Additionally, developments in network browsing and searching tools have enabled information seekers and information providers to search and post images on network content. However, the current image search engines and modules (i.e., Google™ Image Search, etc.) are text-based, meaning the search modules search through text surrounding an image locating and retrieving those images with relevant text. In many instances, undesired images and content are still included in the search results.

In one embodiment of the present invention, there is a system and method for organizing, posting, and searching specific content on a network through the use of images and image searching technology.

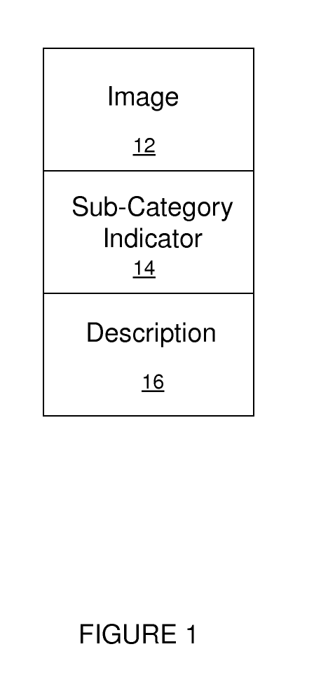

FIG. 1 is a relational diagram illustrating a system and method for organizing, posting, and searching specific content on a network. There is shown an image 12 associated with a sub-category indicator 14, the sub-category indicator 14 being associated with a description 16. In one embodiment, an information provider may incorporate the image 12, the sub-category indicator 14, and/or the description 16 into network content, such as a webpage. An information seeker searching a vast network, such as the internet, may then be able to locate and/or retrieve the specific network content from the information provider by specifically searching for the image 12, the sub-category indicator 14, and/or the description 16.

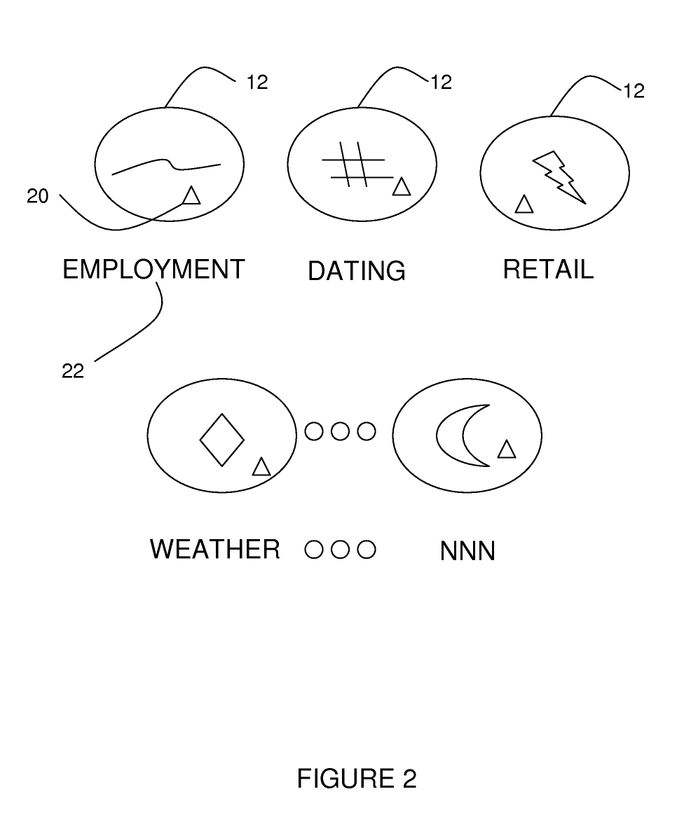

In FIG. 2 there is shown an image 12. In one embodiment, the image 12 is indexed according to and/or representative of a search category 22. The search categories 22 may include any type and/or kind of search category contemplated in the art, or category of information searchable via a network. As illustrated, some non-limiting examples of search categories 22 include: employment, dating, shopping, weather, adult content, network spam, sports, and/or so forth. Advantageously, in this manner, an information provider may incorporate the image 12 corresponding to the information provider's particular search category, enabling more exposure to those searching for the image 12. In a like manner, an information seeker searching for network content in search category 22 may search for the image 12 and thereby exclude undesired and/or non-relevant network content.

Also shown in FIG. 2, the image 12 includes a first characteristic 20. In one embodiment, the first characteristic 20 functions to enable a search module, webcrawler, and/or information seeker to recognize, locate and/or retrieve the network content wherein the image 12 may be incorporated, thereby further excluding undesired and/or non-relevant content. The first characteristic 20 may be any type and/or kind of characteristic recognizable by a search module, webcrawler, and/or information seeker. In a non-limiting example, the first characteristic 20 is selected from the group consisting of: size, color content, electronic and/or digital watermark, textual content, graphical content, and any combinations thereof.

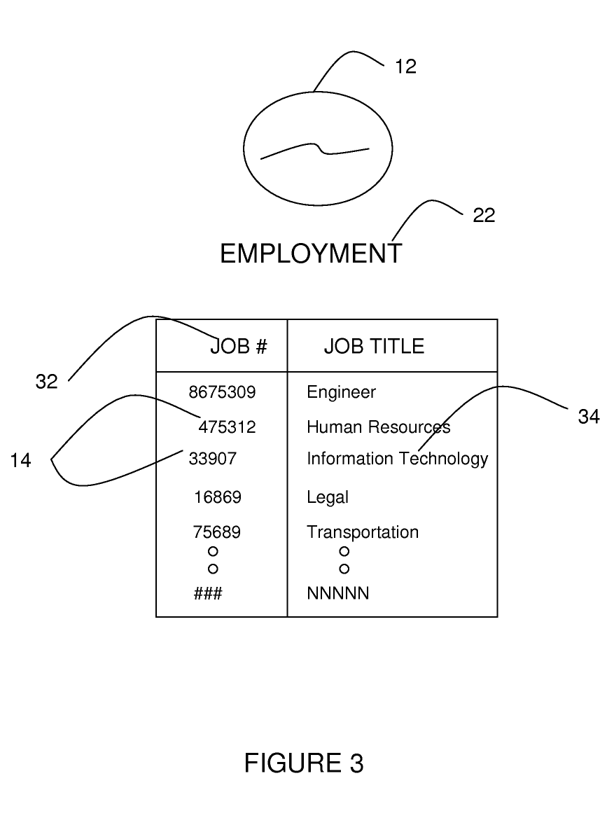

FIG. 3 illustrates an image 12 including a first characteristic 20 and one or more sub-category indicators 14 associated with the image 12. In one embodiment, the sub-category indicator 14 functions to associate and/or link together the sub-category indicator 14 and the image 12, thereby enabling a user to more specifically locate, retrieve search results from a search category and a sub-category. Additionally, the sub-category indicator 14 may further divide the search category 22 associated with the image 12 into subcategories. As shown, the image 12 is indexed to the search category 22 of employment and the one or more sub-category indicators 14 are indexed according to employment type and/or title. The sub-category indicator 14 may be any type and/or kind of sub-category indicator as contemplated in the art and/or as recognizable by a search module, webcrawler, and/or user. As shown, the sub-category indicator 14 may be embodied as a code 14. In a non-limiting example, the code 14 may be embodied in or be the file name of the image 12, 8675309.jpg.

In one embodiment, there may be one more sets of subcategories 34 and corresponding sub-category indicators 14. The one or more sets of subcategories 34 and sub-category indicators 14 may be organized and/or include any subcategories contemplated in the art. In a non-limiting example, an image 12 and corresponding search category 22 for employment may include a multiple sets of sub-categories 34 and associated sub-category indicators 14, such as, but not limited to job type, job position, job salary, location, benefits, and/or so forth. Advantageously, having multiple sub-categories 22 and subcategory indicators 14 may enable a user to limit a search by more than one sub-category indicator, thereby obtaining more specific search results. In a like manner, an information provider may be able to post a plurality of sub-category indicators 14 in network content, thereby enabling more specific targeting of information to users.

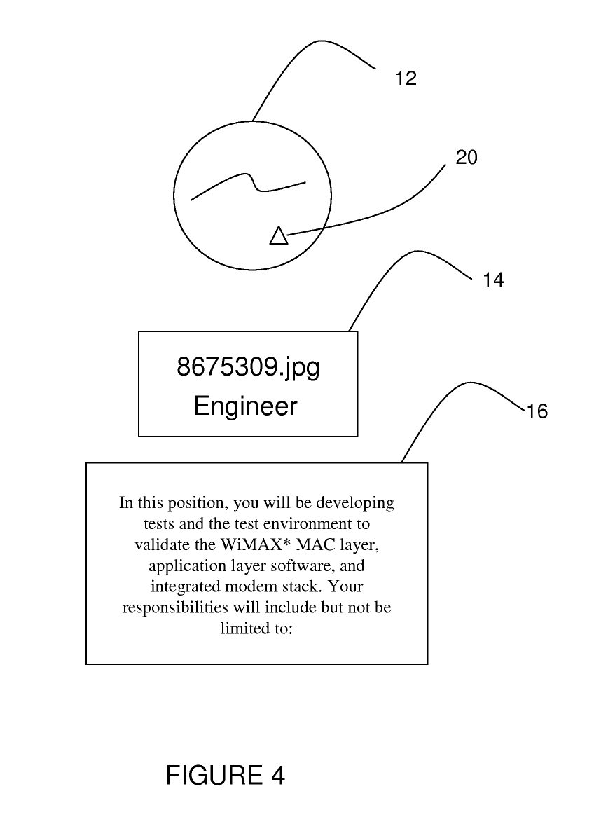

FIG. 4 is a relation diagram illustrating a system and method for posting and searching specific content on a network. Additionally, FIG. 4 may represent network content presented by an information provider. There is shown an image 12 and a sub-category indicator 14, as previously described. There is also shown a description 16 associated with the sub-category indicator 14. In one embodiment, the description 16 represents the target information and/or network content associated with a sub-category indicator 14. This description may be the network content an information seeker is seeking, or similarly the network content an information provider is providing. As shown, the description 16 includes a job/employment description associated with an engineer employment; where engineer is the sub-category indicator 14 and employment is represented by the image 12.

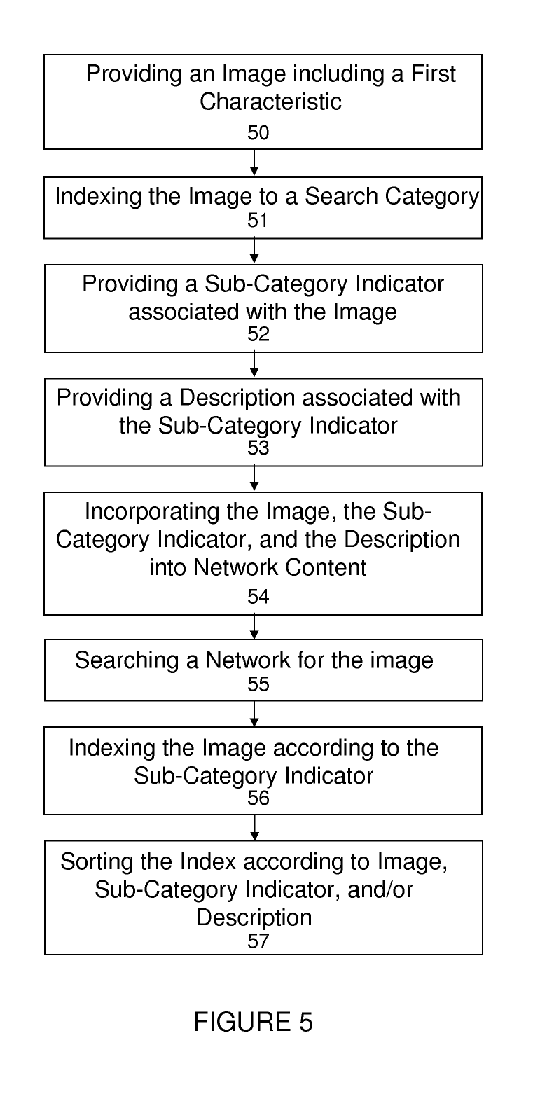

FIG. 5 is a flowchart illustrating a method for organizing, posting, and searching specific content on a network. The steps of the method include: providing 50 an image, the image including a first characteristic; indexing 51 the image according to a search category; providing 52 a sub-category indicator, configured to represent a sub-category associated with the image; providing 53 a description associated with the sub-category indicator; and incorporating 54 the image, the sub-category identifier, and the description into network content.

In one embodiment, as described previously, the image 12 may be any type and/or kind of image or be and/or be embodied in an image contemplated in the art, such as but not limited to a graphical or virtual icon, a digital and/or electronic watermark, a URL and/or IRL network address, a ftp and/or http address, and/or so forth. The image may include a first characteristic 20, the first characteristic 20 being embodied and/or including any type of characteristic contemplated in the art, or as described herein.

As shown FIG. 5, the method also includes incorporating 54 the image, the sub-category indicator, and/or the description into network content. One skilled in the art would realize there a variety of ways and manners in which the image 12, the sub-category indicator 14, and the description may be incorporated into network content. In a non-limiting example the image, sub-category indicator, and/or the description may be visually and/or non-visually displayed on a network page. Alternatively, the image 12 and the sub-category indicator 14 may be incorporated into network content as an electronic/digital watermark, while the search category 22, sub-category 34, and/or the description 16 are visually displayed on the network page.

Also shown in FIG. 5, the illustrated method includes the steps of: searching 55 a network for the image; indexing 56 the image according to a sub-category indicator; and sorting 57 the index according to an image, a sub-category indicator, a description, and/or any combination thereof.

In one embodiment, searching 55 a network for the image may also include searching for the image including the first characteristic 20 over a network. Searching 55 for the image and/or first characteristic may be carried out in any manner contemplated in the art, such as but not limited through the use of search modules, search engines, web and/or network crawlers or spiders, and/or so forth. In a non-limiting example, the image and/or first characteristic may be search using an image-based search engine such as taught in U.S. Pat. No. 6,628,824, which is incorporated by reference herein for its supporting teachings.

Advantageously, in one embodiment, using an image based search engine/module may retrieve only those search results containing the image 12. Further, including both the image 12 and the first characteristic 20 in a search may further enable an information seeker to retrieve only those results he or she desires. In contrast, the current image search engines and modules (i.e., Google™ Image Search, etc.) which are text-based search through text surrounding an image locating and retrieving those images with relevant text, thereby including undesired images and/or results.

As illustrated in FIG. 5, the method also includes indexing 56 the image according to a sub-category indicator. Indexing 56 the image according to a sub-category indicator may be accomplished and/or include any features contemplated in the art. In a non-limiting example, search results and/or locations associated with an image for employment may be indexed according to the one or more sub-categories indicators associated with the employment image, such as, but not limited to job position, job type, compensation, location, and/or so forth.

Additionally, FIG. 5 illustrates sorting 57 the index according to a sort variable such as but not limited to, the image, the sub-category indicator, and/or the description. One skilled in the art would realize there are many methods and/or system for sorting an index, such as but not limited to, through a data sorting module, database module, and/or so forth. In a non-limiting example, an information seeker may sort the results of a search according to a sub-category indicator, thereby viewing the more relevant and/or desired results first. Sorting 57 the index may also comprise excluding those results and/or network locations not containing one or more of the sorting variables.

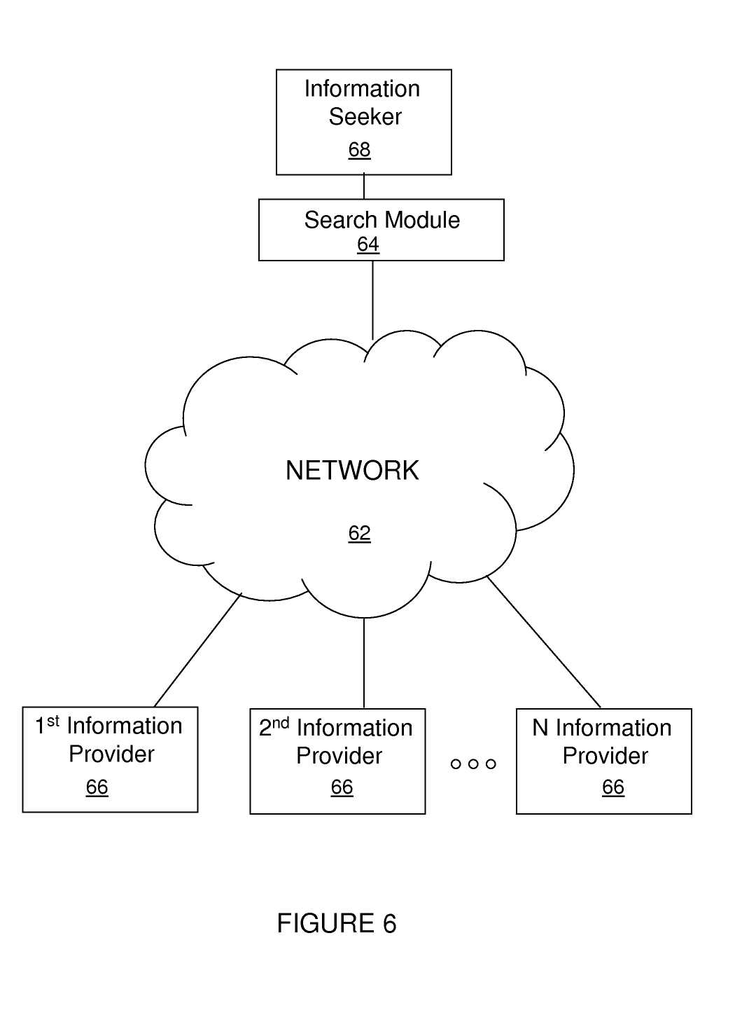

FIG. 6 illustrates a network diagram of a system and method for posting and searching specific content on a network, according to one embodiment of the invention. There is shown an information seeker 68 and a search module 64 in communication with one or more information providers 66 via a network 62. Advantageously, the present invention may enable an information seeker 68 through a search module to search through the vast amounts of network information providers 66 for that network content including the image 12, first characteristic 20, sub-category indicator 14, and/or description 16.

In a non-limiting exemplary embodiment of FIG. 6, the information seeker 68 may include a person seeking a specific type of employment, such as engineer, from his or her home. The information seeker 68 may obtain the search module 64, via download, purchase, third parties, etc. The information seeker 68 may then obtain the image 12 and sub-category indicator 14 associated with his or her specific employment preferences, such as electrical engineer located on the west coast. The information seeker 68 may use the search module 64 and search the entire network/internet 62 using the image for employment 12, the sub-categories indicators for electrical engineer 14 and for west coast locations XX. The search results obtained from the search would only include those employment opportunities for electrical engineers on the west coast.

In one embodiment, there may be listings and/or information regarding images 12, sub-category indicators 14 and their associated search categories 22 and sub-categories 34, respectively. The listings and/or information may be available over a network 62 such as the Internet 62 and/or from any other source.

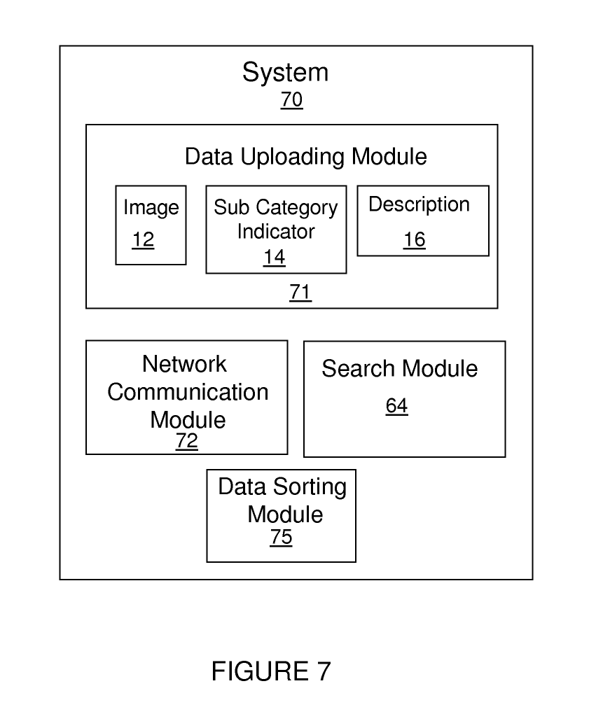

FIG. 7 is a block diagram illustrating a system 70 for posting and searching specific content on a network, according to one embodiment of the invention. The system 70 comprises: a network communication module 72, a data uploading module 71 in communication with the network communication module 72, a search module 73, and a data sorting module 75.

As shown in FIG. 7, the data uploading module 71 includes modules and/or data associated with: an image 12 including a first characteristic, a sub-category indicator 14, and a description 16. In one embodiment, the data uploading module 71 is configured to and includes instructions for: uploading an image 12, the image indexed to a search category 22, and including a first characteristic 20; uploading a sub-category indicator 14, the sub-category indicator 14 being associated with the image 12; and uploading a description associated with the sub-category indicator 14. The image 12, the first characteristic 20, sub-category indicator 14, and description 16 may include or be embodied in any features, modules, functions, etc. as contemplated in the art, or as described herein. The data uploading module 71 may be any type and/or kind of data uploading module contemplated in the art, such as but not limited to web-builders or such as those taught in U.S. Publication No. 20040145603, which publication is incorporated by reference herein for its supporting teachings.

As shown in FIG. 7, the system 70 also includes a network communication module 72. The network communication module 72 may be any type and/or kind of network communication module contemplated in the art that functions and/or assists in communicating information and/or data via a network and/or that assists in connecting information providers 66 and/or information seekers 68 to and/or through a network. The network communication module 72 may be an advanced system and/or software such as those available through Iperia, Inc. of North Billercia, Mass. Additionally, the network communication module 72 may comprise standard network communication and/or service via a local/national/international company such as, but not limited to Qwest, Comcast, AOL, and/or so forth.

FIG. 7 also shows a search module 73 in communication with the network communications module 72. The search module 73 may be configured to and/or includes instructions for: searching a network and/or network content for: an image 12 and/or an image 12 including a first characteristic 20; and indexing the location of the image according to a sub-category indicator 14. Additionally, the search module 73 may comprise a webcrawler 74. The search module 73 may be any type and/or kind of search module contemplated in the art, or as described herein. In an additional embodiment, the search module 73 may be configured to and/or include instructions for searching for the image 12 and/or first characteristic 20, the sub-category indicator 14, and/or the description 16.

As illustrated in FIG. 7, the system 70 additionally includes a data sorting module 75 in communication with the search module 73. The data sorting module 75 may be configured to and/or include instructions for sorting the index according to data selected from the group consisting of: the image 12, first characteristic 20, the sub-category indicator 14, the description 16, and any combinations thereof. The data sorting module 75 may be any type and/or kind of search module contemplated in the art, or as described herein. In one embodiment, the data sorting module 75 may be an advanced system and/or software such as those available through CoSORT version 9 software of Melbourne, Fla. Additionally, the data sorting module 75 may be standard data sorting software as used in Microsoft Excel and other similar programs.

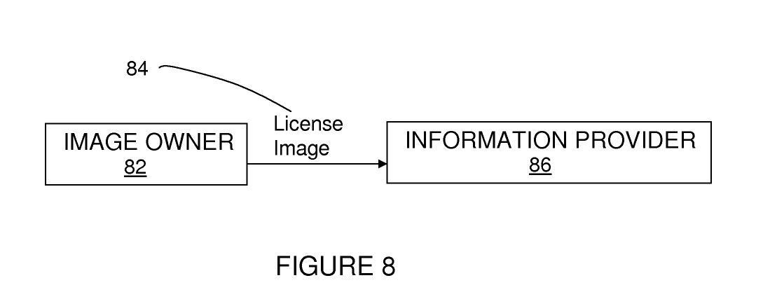

FIG. 8 illustrates a relational diagram and flowchart for the system and method for posting and searching specific content on a network, according to one embodiment of the invention. There is an image owner 82 licensing the image 12 and/or use of the image 12 to one or more information providers 66. The image owner 82, in owning the image may desire to establish and/or have established ownership rights to the image. Ownership rights may include any type of ownership rights contemplated in the art, such as but not limited to: trademark, copyrights, patent, moral, business competition, and/or so forth.

In one embodiment, establishing ownership rights of the image and licensing use of the image to information providers advantageously allows the image owner and/or the image licensees the ability to prevent undesired, damaging, disruptive, and/or otherwise improper use of the image 12. Enabling the image owner 82 and licensee information providers 66 to prevent unlicensed and/or unauthorized used of the image may benefit both those information providers 66 and those information seekers 68 as undesirable and/or damaging network content may be excluded. Accordingly, an image owner 82 may be enabled to maintain a substantially open search network while also maintaining a high quality of search results.

In an additional embodiment, the system and method for posting and searching specific content on a network may include a network filtering system and apparatus. With the prevalence of high risk and/or dangerous network content and locations, the network filtering system may filter out adult content, viruses, spam, and/or other dangerous content away from children, important computers and servers, and so forth.

In another embodiment, the network filtering system may include a networking filtering module including instructions and/or configured to filter network content according to the presence/absence of one of the following selected from the group consisting of: the image 12, the image 12 including the first characteristic 20, the sub-category indicator 14, the description 16, and any combinations thereof.

In an exemplary embodiment, dangerous and/or undesired network content such as adult content, gambling etc. may be required to incorporate the image and/or image including the first characteristic. Advantageously, the network filtering module may then filter out and/or exclude the dangerous content, thereby preventing minors and/or otherwise unlawful views from retrieving the content. The network filtering system may be embodied and/or include any features, module, components, etc. as contemplated in the art. In a non-limiting example, the network filtering system includes any features, module, components, etc such as taught by U.S. Pat. No. 7,215,947 and U.S. Pat. No. 7,103,915, which are incorporated by reference herein.

In an additional embodiment, the system and method of posting and searching specific network content includes and/or is embodied in a central database module and/or system. The central database module may be in communication with one or more information providers 66 and/or information seekers 68 through a network. The central database module may include a data storage module and/or any other features and modules as described herein. The central database module may be configured to and/or include instructions for enabling a job seeker to post his or her resume and/or descriptive content and incorporate the image 12, including the first characteristic 20 and one or more sub-category indicators 14. In this manner, an information seeker 68, or employer, may search the central database module for the images and sub-categories as described herein.

In another embodiment, the central database module may be configured and/or include instructions for enabling an information provider 66, such as, but not limited to an employer, to post and/or display employment postings through the central database module, thereby enabling an information seeker 68, or employment seeker, the ability to search using the image 12 and sub-category indicators 14.

In yet another embodiment, the central database module may include a graphical user interface module and a network interface module. The GUI module and the network interface module may function to enable information providers and seekers to retrieve information on images 14, sub-category indicators 16, as well as post and search for other information providers and seekers. Additionally, the central database module may include an image and/or sub-category indicator incorporation module. The image and/or sub-category indicator incorporation module may be configured to and/or include instructions for incorporating the image 12 and/or sub-category indicators 14 into network content.

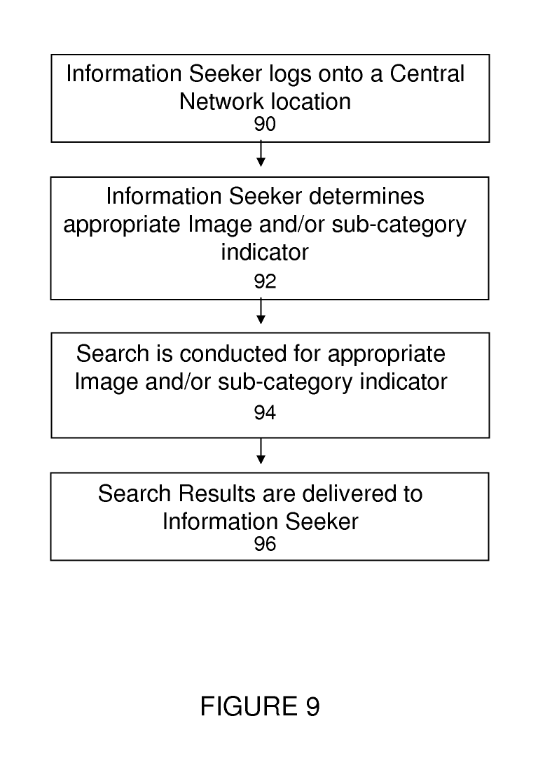

FIG. 9 is a flowchart illustrating a method for an information seeker searching specific content on a network, according to one embodiment of the invention. As the method includes an information seeking visiting 90 one or more central network locations; the information seeker determining 92 appropriate image(s) and/or sub-category indicator(s); conducting 94 a search for network content associated and/or including the appropriate image(s) and/or sub-category indicator(s); and delivering 96 the results of the search to the information seeker.

In one embodiment, an information seeker visiting 90 one or more may include and/or be embodied in any manner contemplated in the art. In a non-limiting example, an information seeker may visit, log onto, download, etc. one or more central network locations such as but not limited to one more internet websites and/or web pages. Visiting 90 one or more central network locations may include an option for an information seeker and/or information provider to register with one or more of the central network locations.

Also shown in FIG. 9, the method includes an information seeker determining 92 an appropriate image and/or sub-category indicator in accordance with the network content the information seeker desires. Determining 92 an appropriate image and/or sub-category indicator may be accomplished and/or include any features contemplated in the art. In one non-limiting example, the one or more central network locations may include a central database module as described herein. The central database module may include a searchable database providing options for searching search categories and their associated images and/or sub-categories and their associated sub-category indicators. In another non-limiting example, the central database module may include a series of questions, icons, and/or assistance modules which function to assist an information seeker and/or information provider in determining an appropriate image and/or sub-category indicator.

As shown in FIG. 9, upon determining an appropriate image and/or sub-category indicator, an information seeker may conduct 94 a search for network content which includes the appropriate image and/or sub-category indicator. Searching 94 through network content for the appropriate image and/or sub-category indicator may be accomplished in any manner contemplated in the art, or as described herein.

FIG. 9 additionally illustrates that search results are delivered 96 to the information seeker. Delivering 96 search results may be accomplished in any manner contemplated in the art, such as but not limited to, displaying, emailing, mailing, and/or so forth.

In a non-limiting, exemplary embodiment an information seeker 68 may include any type of information seeker contemplated in the art, or as described herein, such as but not limited any individual, group, and/or entity seeking information via network content. In a non-limiting example, an information seeker may be an individual, group of individuals seeking information regarding specific employment opportunities and/or employment postings. Alternatively, an information seeker 68 may be an employer seeking information regarding specific individuals. Both the individual(s) and the employer may be searching for specific employment postings and individual resumes, respectively.

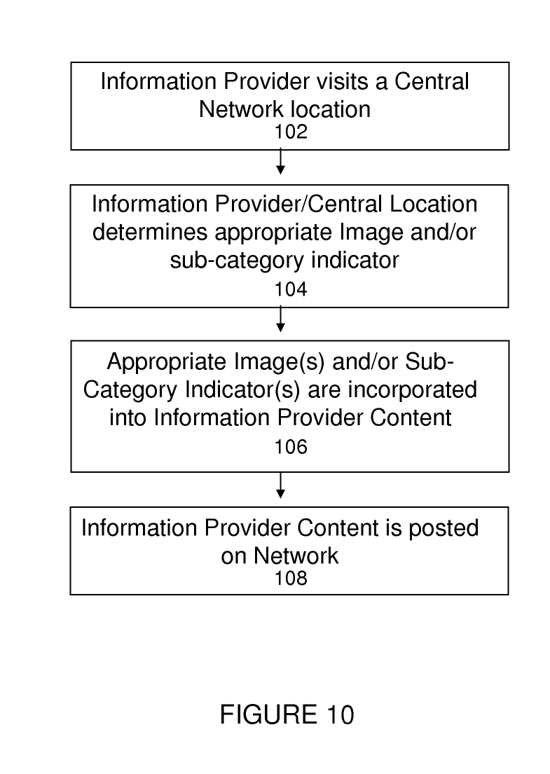

FIG. 10 is a flowchart illustrating a method for an information provider 66 to incorporate an image and/or sub-category indicator into network content. As shown an information provider 66 visits 102 one or more central network locations; an information provider 66 determines 104 appropriate images and/or sub-category indicators; the appropriate images and/or sub-category indicators are incorporated 106 into the information provider content; and the information provider content, including the image(s) and/or sub-category indicator(s) are posted 108 and/or displayed 108 on and/or through a network. An information provider visiting 102 one or more central network locations and determining 104 appropriate image(s) and/or sub-category indicator(s) may be accomplished any manner contemplated in the art, or as described herein.

As illustrated in FIG. 10, the method includes incorporating 106 appropriate image(s) and/or sub-category into information provider content. Incorporating 106 appropriate image(s) and/or sub-category into information provider content may be accomplished in any manner contemplated in the art, or as described herein. In a non-limiting example, image(s) and/or sub-category indicators may be incorporated into information provider content which is already network based content, such as but not limited to, information provider web pages, sites, etc. In another non-limiting example, an information provider and/or 3^{rd} party may incorporate image(s) and/or sub-category indicators into content which may then be modified, uploaded, and/or created to become network and/or web-based content.

In a non-limiting exemplary embodiment, the operation of the system and method for posting and searching specific content on a network may provide both information seekers 68 and information providers 66 a network resource and tool that enable specific searching and posting of network content and exclusion of undesired and/or dangerous network content. There may be an information provider 66, such as an employer, who desires to post one or more employment positions and wishes to target specific potential employees with specific skills and/or resources. The information provider/employer 66 may incorporate the image 12 including the first characteristic 20 into network content and/or network page together with one or more of the sub-category indicators 14 associated with the type of employment and desired skills and/or resources the information provider 66 desires. In this manner, an information seeker 68 seeking employment with skills and desires associated with the sub-category indicators may specifically search a vast network, such as the internet, for the information providers/employers network page.

In an alternative exemplary embodiment, an information provider 66 may desire to provide information and/or target his or her information to potential employers regarding his skills and employment desires. The information provider 66 may incorporate an image 12 into network content, the network content comprising the information provider's 66 resume and/or other descriptions, together with one or more sub-categories 34 associated with information provider's 66 skills, employment desires, etc. In this example, an information seeker 68 may be an employer searching for a particular potential employee with skills and/or employment desires. In this manner, an employer seeking potential employees may search a network using the image 12 together with one or more sub-category indicators 14, and retrieve only that network content and/or resumes who have desired image 12 and sub-category indicator 14.

In one embodiment, some of advantages and benefits offered by the system and method for organizing, posting, and searching for specific network content are highly advanced search results for both information providers 66 and information seekers 68; increased efficiency and decreased timelines for information providers and seekers to find and retrieve information; increased organization in large networks, such as the Internet; and increased network and public awareness for information providers.

Advantageously, in another embodiment, the system and method as described herein may be applicable in organizing networks and/or the network content contained therein. In a non-limiting example, a vast network, such as the Internet, may be organized wherein information providers 66 incorporate an image 12 and/or sub-category indicator into the information provider's 66 internet content. The organizational structure is simple, yet very effective. An information seeker 68 may quickly and easily search for desired content by using the image 12 and/or sub-category indicator (s) 14.

In yet another embodiment, the system and method may enable an information seeker 68 to search at varying levels of specificity. For example, those information seekers desiring to ranging from general to very specific. In a non-limiting example, an information seeker 68 may desire merely to browse through a search category, such as but not limited to sports. The information seeker 68 need only use the appropriate image 12 in his or her search. If an information seeker 68 desires to increase the specificity of a search, he or she need only increase the number of sub-category indicators 14 in his or her search.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although FIG. 4 shows the description 16 as including text it is envisioned the description 16 may include any feature, components, modules, etc. contemplated in the art through which information may be conveyed. Some non-limiting examples of description 16 features include: graphics, images, photos, text, media, flash programs, and/or so forth.

Additionally, although many of the exemplary embodiments are associated with employment searching and listing, the system and method for posting and searching specific content on a network may be applicable to any network content, such as but not limited to shopping, sports, news, social networks, adult content, and network spam. In a non-limiting example, a network provider of goods and/or services, i.e., information provider, may incorporated the image 12 and one or more sub-category indicators into the network content associated with their goods and/or services, thereby enabling potential buyers/clients more rapid, efficient access to the network provider. In another non-limiting example, the system and method for posting and searching specific content on a network may be applicable to online social network and/or dating services, through incorporating the image 12 and/or sub-category indicators 14 into the social network content.

It is also envisioned that network content may be type of network content and/or network interface contemplated in the art. Some non-limiting examples of network content and/or interfaces include: one or more network/web pages, hyperlinks, network based textual and/or graphical data, network data and/or metadata, data display on a network page, and/or so forth.

Additionally, it is envisioned the system and method is applicable to any type and/or kind of network contemplated in the art, such as but not limited to the Internet, LANs, WANs, private networks, open and/or publicly available networks, and/or so forth.

Further it is envisioned that information providers 66 as shown and described herein refers to any person and/or entity who provides information through network content, including but not limited to persons and/or entities directly and/or indirectly providing the information/data themselves and/or via third parties.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A method for posting and searching specific content on a network, comprising the steps of:
providing an image, the image including a first characteristic, and wherein the image is indexed to a search category;
providing a sub-category indicator, configured to represent a sub-category associated with the image;
providing a description associated with the sub-category indicator; and
incorporating the image, the sub-category identifier, and the description into network content.

2. The method of claim 1, wherein the search category is selected from the group consisting of: employment, shopping, sports, news, social networks, adult content, and network spam.

3. The method of claim 2, wherein the sub-category comprises employment type.

4. The method of claim 3, wherein the network content comprises a network interface.

5. The method of claim 4, further comprising the step of establishing ownership rights to the image.

6. The method of claim 1, wherein the first characteristic is selected from the group consisting of: size, color content, electronic watermark, textual content, graphical content, and any combinations thereof.

7. The method of claim 6, further comprising the steps of:
searching a network for the image; and
indexing the location of the image according to the sub-category indicator.

8. The method of claim 7, wherein the searching comprises searching for the first characteristic.

9. The method of claim 8, wherein the searching comprises web crawling.

10. The method of claim 9, further comprising sorting the index according to data selected from the group consisting of: the image, the sub-category indicator, the description, and any combinations thereof.

11. A computer readable storage medium comprising computer readable program code for posting and searching specific content on a network, and configured to execute on a processor, the program code including instructions for performing the steps of:
providing an image, the image including a first characteristic, and wherein the image is indexed to a search category;
providing a sub-category indicator, configured to represent a sub-category associated with the image;
providing a description associated with the sub-category indicator; and
incorporating the image, the sub-category identifier, and the description into network content.

12. The computer readable storage medium of claim 10, wherein the program code is further configured perform the steps of:
searching a network for the image; and
indexing the location of the image according to the sub-category indicator.

13. The computer readable storage medium of claim 12, wherein the searching comprises web crawling.

14. The computer readable storage medium of claim 11, wherein the program code is further configured perform the step of sorting the index according to data selected from the group consisting of: the image, the sub-category indicator, the description, and any combinations thereof.

15. The computer readable storage medium of claim 11, wherein the search category is selected from the group consisting of: employment, shopping, sports, news, social networks, adult content, and network spam.

16. A system for posting and searching specific content on a network, comprising:
a network communication module; and
a data uploading module in communication with the network module, and configured to upload data into network content, wherein the data uploading module includes instructions for:
uploading an image, the image indexed to a search category, and including a first characteristic;
uploading a sub-category indicator, the sub-category indicator being associated with the image; and
uploading a description associated with the sub-category indicator.

17. The system of claim 16, further comprising a search module in communication with the network communication module, the search module configured to search network content.

18. The system of claim 17, wherein the search module includes instruction for:
searching the network for the image; and
indexing the location of the image according to the sub-category indicator.

19. The system of claim 18, further comprising a data sorting module in communication with the network communication module, and including instructions for sorting the index according to data selected from the group consisting of: the image, the sub-category indicator, the description, and any combinations thereof.

20. The system of claim 17, wherein the search module comprises a web crawler.
